(19) United States
(12) Patent Application Publication
(10) Pub. No.: US 2004/0198434 A1
(43) Pub. Date: Oct. 7, 2004

(54) Wireless communication device

(75) Inventors: Nicholas Holder Clarey, Cambridge (GB); Jonathan Daniel Hawkins, Trumpington (GB)

Correspondence Address: BOURQUE & ASSOCIATES, P.A., 835 HANOVER STREET, SUITE 303, MANCHESTER, NH, 03104, US

(73) Assignee: 3G LAB Limited

(21) Appl. No.: 10/350,959

(22) Filed: Jan. 24, 2003

(30) Foreign Application Priority Data
Sep. 13, 2002 (GB) 0221181.1

(51) Int. Cl. H04M 1/00

(52) U.S. Cl. 455/556.1; 455/550.1

(57) ABSTRACT

A mobile communications terminal in which the user interface is assembled by assembling a number of software objects representing logical entities; querying each of the objects to receive data relating to the represented entities; applying a translation entity and a presentation entity to the received data to create a display data set; and sending the display data set to a renderer that can cause the user interface to be displayed on a display device.

### BACKGROUND OF THE INVENTION

This invention relates to the field of wireless communication devices and specifically to man-machine interfaces suitable for use with wireless communication devices.

Man-machine interfaces (MMIs) are traditionally described by a set of logical units which call functions in a library on the device. The library provides a set of functions which display user interface components on the screen and by calling these library functions in certain ways, and tying them together using program logic, the MMI writer is able to render to the screen a graphical depiction of the desired interface.

This approach has a number of disadvantages, for example, using program logic to provide a rendered MMI requires quite different skills to the skills required to describe an ergonomic and aesthetically pleasing MMI. Additionally, it is often awkward and undesirable to make changes to the MMI once the communication device is deployed in the marketplace and a new look-and-feel to the MMI usually requires significant effort on the part of the programmer to customise the library calls or the logical units for the newly desired behaviour or appearance.

Therefore, it is desirable to try to discover an approach to this problem that allows the writer of the logical units to work in a fashion that is independent of the designer of the MMI. This creates an “interface” between the two concerned parties, and allows for freedom to customise both sides of the “interface” at a late stage in production, or in fact once the wireless communication device has been deployed.

### SUMMARY OF THE INVENTION

According to a first aspect of the present invention there is provided a mobile communications terminal comprising a presentation entity and a plurality of logical entities; the presentation entity comprising one or more presentation data sets and each logical entity having an associated software entity, the user interface for the mobile communications terminal being generated, in use, by polling one or more of the software entities to receive data representing the state of the or each associated logical entity and then arranging the received logical entity data in accordance with a presentation data set.

The user interface for the terminal may be changed by applying a further presentation data set to the received logical entity data. The series of software entities that are polled may be altered and the further presentation data set applied to the altered logical entity data. The user interface for the terminal can be updated by refreshing the data polled from the one or more software entities.

The terminal may further comprise one or more display devices on which the terminal user interface can be displayed. The terminal may further comprise user input means.

Preferably the terminal further comprises a control entity that, in use, determines the software entities to be polled, receives the logical entity data from the polled software entities and applies a presentation data set to the received data to create a user interface data set. The terminal may further comprise a rendering entity, and, in use, the control entity may send the display data set to the rendering entity, the rendering entity transforming the user interface data set such that it can be displayed. The presentation data set may additionally comprise translation data.

According to a second aspect of the present invention there is provided method of operating a mobile communications terminal, the method comprising the steps of: (a) generating one or more data items representing one or more logic entities within the terminal by polling the one or more logic entities; (b) applying a presentation data set to the generated data items to generate a user interface data set for the terminal.

Additionally the method may comprise the additional step of applying a translation data set to the generated data items before carrying out step (b). The method may also comprise the additional step of (c) rendering the user interface data set and sending the results to a display device. Additionally, a presentation data set or a translation data set may be compiled into a binary format and transmitted to the terminal.

### BRIEF DESCRIPTION OF THE DRAWINGS

These and other features and advantages of the present invention will be better understood by reading the following detailed description, taken together with the drawings wherein:

FIG. 1 shows a schematic depiction of a wireless communication device according to the present invention;

FIG. 2 shows a schematic depiction of the operation of the wireless communication device shown in FIG. 1;

FIG. 3 shows a flowchart that outlines the operation of the engine;

FIG. 4 shows a flowchart that describes the functioning of an actor following a request from the engine;

FIG. 5 shows a flowchart that describes the operation of the renderer;

FIG. 6 shows a flowchart that describes the function of the agent;

FIG. 7 shows a flowchart describing the process by which a MMI can be authored or modified; and

FIG. 8 shows a binary code compilation method is described in the form of a class diagram.

### DETAILED DESCRIPTION OF THE EXEMPLARY EMBODIMENTS

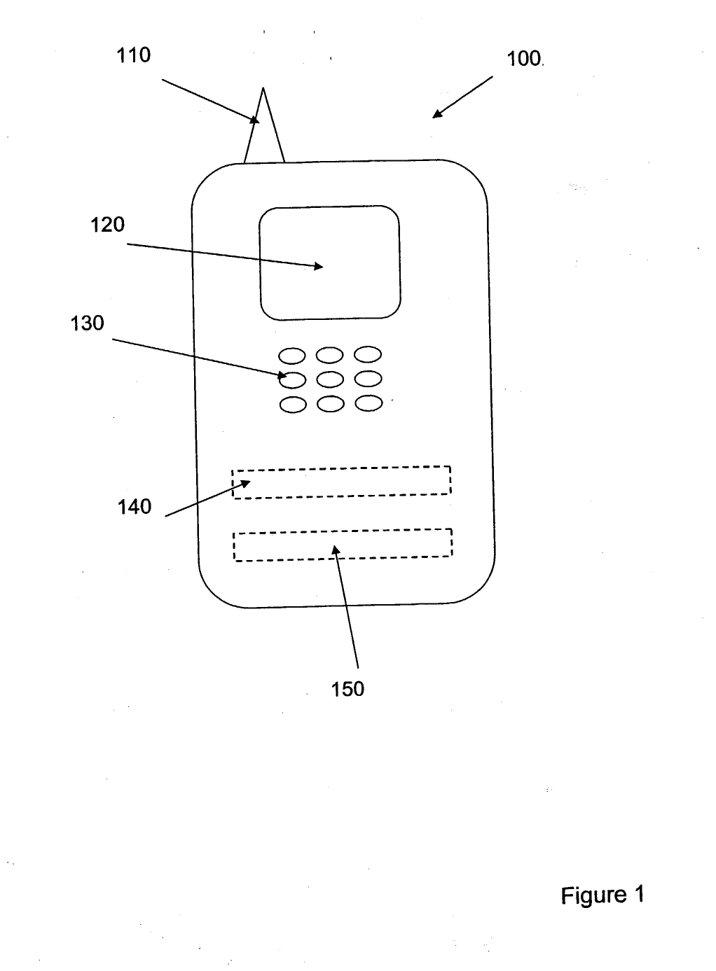

FIG. 1 shows a schematic depiction of a wireless communication device 100 according to the present invention. The device 100 comprises antenna 110, display screen 120, input interface 130, processor 140, storage means 145, operating system 150 and a plurality of further application programs 155.

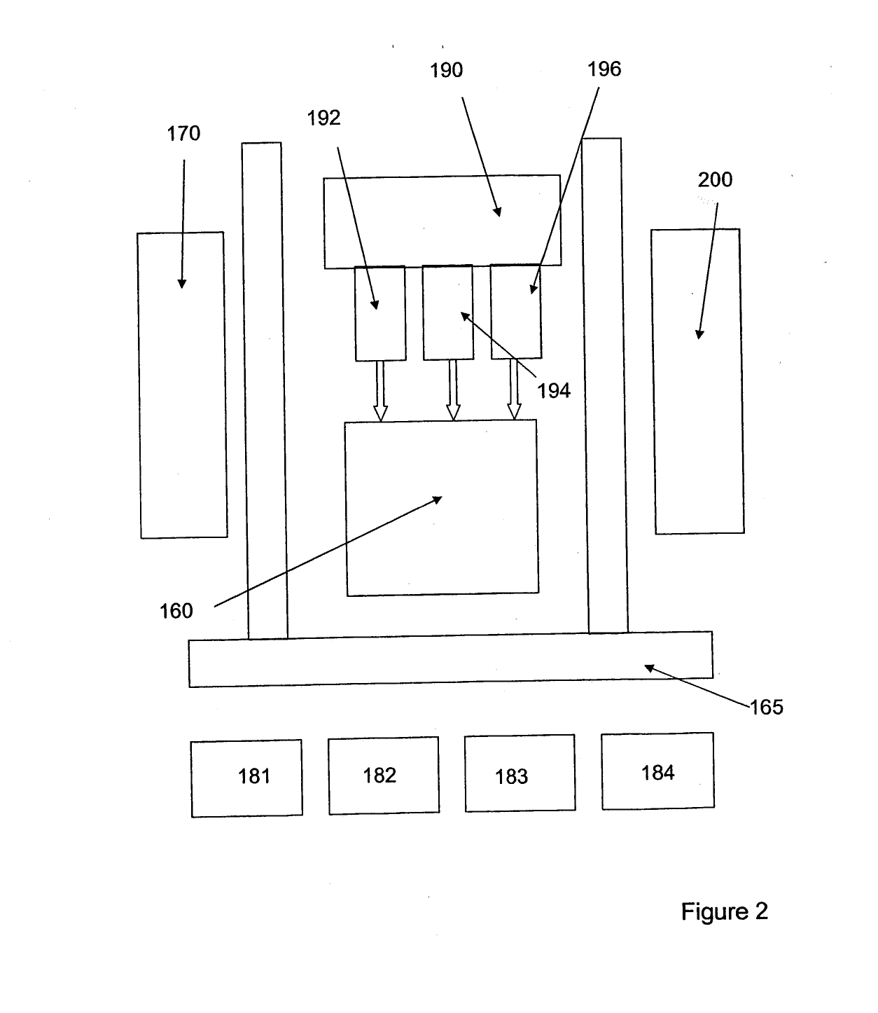

FIG. 2 shows a schematic depiction of the operation of the wireless communication device 100 shown in FIG. 1. Engine 160 is in communication with message-based interface 165 that enables data to be sent and received from other system components. A resource manager 190 manages the storage of a shots entity 192, translation transform entity 194 and presentation transform 196 and it co-ordinates the passing of data from these entities to the engine 160. A collection of shots constitute a scene. A shot may refer to static data or to dynamic data which will initiate an actor attribute query. The agent 200 passes updates to the resource manager and update notifications to the engine 160 via the interface 165. A renderer 170 receives a range of media elements, images, sounds etc from the resource manager 190. In an alternative implementation, multiple renderers may be used for different media types, such as audio content. The invention is also applicable to mobile devices with multiple screens, in which case multiple display renderers may be used. The renderer also receives renderer content from and sends user input data to the engine 160. The engine is also in communication with a plurality of actors 180; for the sake of clarity only actors 181, 182, 183, 184 are shown in FIG. 2 but it will be appreciated that a greater or lesser number of actors could be in communication with the interface 165.

The actors 180 represent the logical units of the wireless communication device such as, for example, the display screen, the renderer, input interface, power saving hardware, the telephone communications protocol stack, the plurality of further application programs, such as a calendar program. The renderer 170 is a computer program responsible for accepting an object description presented to it and converting that object description into graphics on a screen. The engine 160 has a number of functions that include: requesting and registering to receive updates to data from the actors 180; reading an object-based description of the data to query (which is referred to as a shot); taking data received from the actors 180 and placing the data into a renderer-independent object description of the desired MMI presentation (called a take); translating the renderer-independent object description into a new language, for example German, Hebrew, Korean, etc., as a result of the application of a translation stylesheet; and taking the translated renderer-independent object description and converting the data into a renderer-dependent object description as a result of the application of a presentation stylesheet. The agent is a further program 190 responsible for receiving communications from other entities and converting information received from those entities into requests for updates to actors, scripts, translation transforms, or presentation transforms. A script is the full collection of scenes and shots that make up the behavioural layer of an MMI. A shot comprises one or more spotlights, with a spotlight comprising zero or more actor attribute queries. A spotlight without an actor attribute query constitutes a piece of content which is static before application of the presentation or language transform. An example of a basic user interface comprising one scene and a number of shots is given in Computer Program Listing A below.

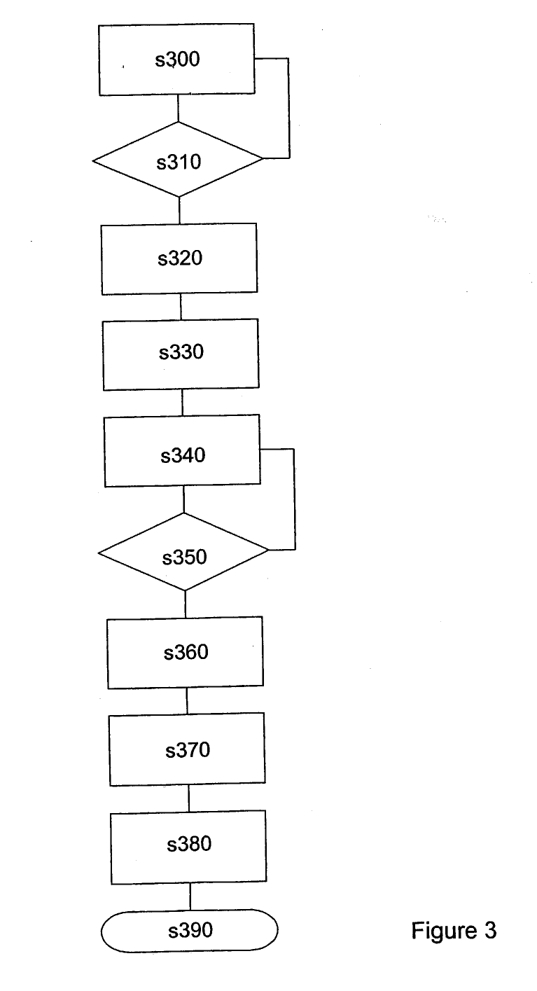

The operation of the system described above with reference to FIG. 2 will now be summarized. FIG. 3 shows a flowchart that outlines the operation of the engine 160. At step 300, the engine informs itself of the existence of installed actors by referring to a resource list installed alongside the script. At step 310, each actor establishes communication with the engine by registering with it. If communication has not been established with all the actors then step 310 returns to step 300; if communication has been made with all the actors then at step 320 the engine loads a shot from the shot entity 192. The engine is set to first load a predefined scene (the start-up screen) with its constituent shots.

During step 330 the engine 160 assesses and interprets the shot content data in order to determine which actors it will need data from. In step 340 the engine requests data from one or more of the plurality of actors 180 that were identified in the shot content data. During step 350 the engine waits to receive the data from the actors. When all of the requested actors respond then the engine proceeds to step 360; otherwise if one or more of the requested actors fail to respond, for example before a timer expires, then the engine returns to step 340 and additional requests are sent to the actor(s) that have not responded.

The engine then processes the received data to form a take during step 360 which is formatted by the application of a translation stylesheet at step 370 and a presentation stylesheet at step 380. The result of these various steps is an object description that can be understood and implemented by the renderer 170 and the final step 390 of the process is to transmit the object description from the engine to the renderer. The renderer will process the object description, fetch associated referenced graphic or multimedia content from the resource manager and display or otherwise output the MMI defined within the object description to the user.

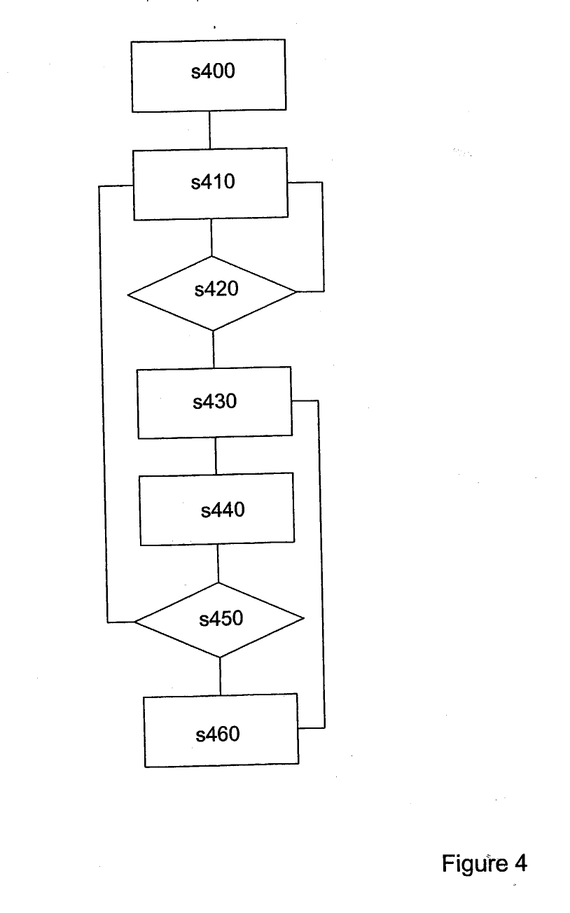

FIG. 4 shows a flowchart that describes the functioning of an actor 180 following a request from the engine. At step 440, the engine establishes communication with the actor and the actor waits at step 410 in order to receive a request for data from the engine. If the request from the engine is valid then the actor proceeds from step 420 to step 430 and formulates a reply to the received request. If the request is not valid then the actor returns to step 410. The formulated reply will be sent to the engine at step 440: if at step 450 the request is now complete then the actor will return to step 410 to await a further data request; otherwise the actor will wait for the data to change (for example a decrease in battery charge level) at step 460 before returning to step 430 to generate a new reply to be sent to the engine.

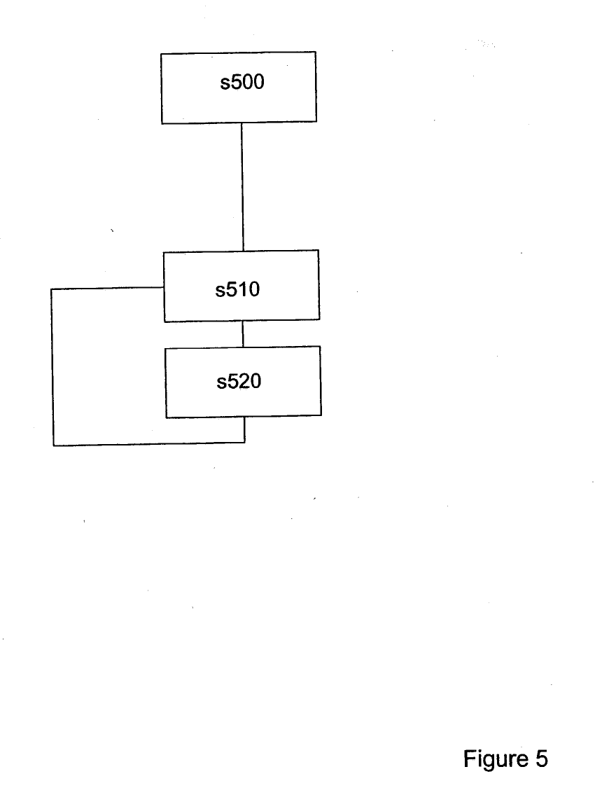

FIG. 5 shows a flowchart that describes the operation of the renderer 170. Once communication has been established with the engine at step 510 then the renderer waits for renderable object description data to be received from the engine (see above) at step 520. When suitable data is received then the data is rendered on the display screen 120 at step 530 and the renderer returns to step 520.

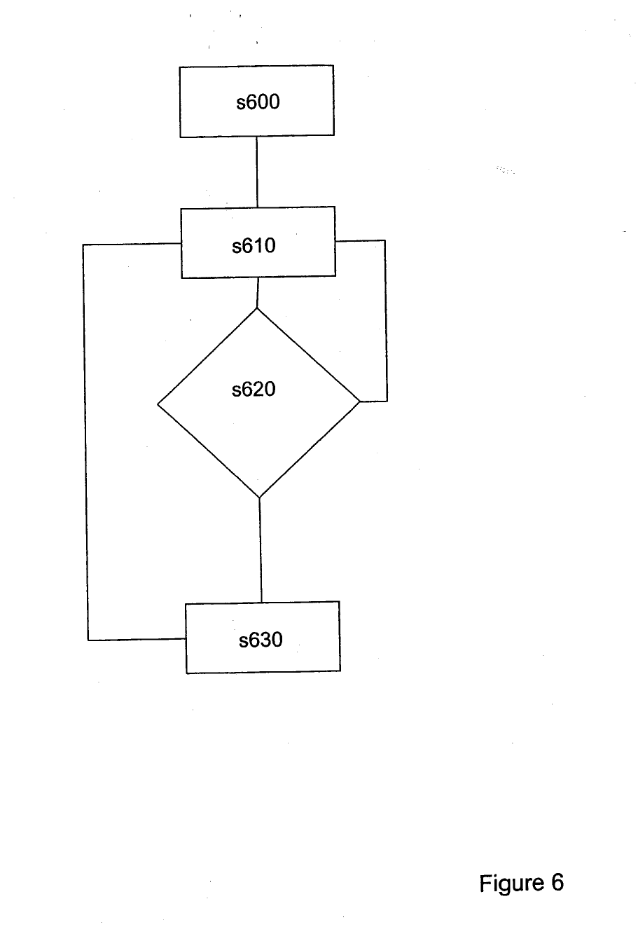

FIG. 6 shows a flowchart that describes the function of the agent. The agent establishes communication with the engine in step 600 and then at step 610 the agent waits to receive updates from the communications network at step 610. If it is desired to change one or more of the actors, translation stylesheet, presentation stylesheet or shots (these can be referred to as “Alterable Entities”), the agent is able to receive network communication from other entities (for example network or service providers, content providers, terminal manufacturers, etc.) containing alterations, additions or removals of an alterable entity. At step 620, the agent examines the received data to ensure that it is an alterable entity update. If so the alterable entity update is passed to the resource manager 190 in order that the appropriate entity is replaced with the updated entity and the entity update is also notified to the engine. If the data received is not an alterable entity update then the agent will discard the received data and will return to step 610 to await the reception of further data from the network.

The agent may initiate the downloading of an alterable entity update in response to a user action or at the prompting of the engine or resource manager (for example, an entity may have been in use for a predetermined time and it is required to check for an update or to pay for the right to continue to use it). Alternatively, updates may be pushed to the agent from a server connected to the terminal via a wireless communications network. To maintain the security and integrity of the terminal, it is preferred that the agent validates downloaded updates against transmission errors, viruses or other accidental or malicious corruption before passing the updates to the resource manager. Additionally, the agent may comprise DRM (digital rights management) functionality, which may include checking that received content has been digitally signed with an originating key that matches a receive key stored within the mobile device. A successful match results in proceeding with installation; an unsuccessful match may result in rejection, or installation of the update with limitations imposed, such as the update being un-installed after a limited period of time or installing the update with restricted functionality. The agent is also capable of prompting the removal of MMI content and/or alterable entities from the resource manager. Content may be removed, for example, after having been installed for a certain period of time, in response to a server command or a user input, or in order to make room for new content in the resource manager, etc.

Although most terminal (and thus actor) functionality will generally be incorporated at the time of manufacture, the invention enables the addition of extra functionality, for example through the connection of a plug-in device such as, for example, a modem for an additional communications network or a non-volatile storage device. In this case, the actor software associated with the plug-in device, which may conveniently be uploaded from the device along a serial connection at the time of attachment, is installed into the actor collection, and a message is sent to the engine to register the new actor. Alternatively, the plug-in device may itself contain processing means able to execute the actor functionality, and communication between the engine and plug-in actor is achieved over a local communications channel. Appropriate de-registration will occur in the event of removal of the plug-in device.

User input events may come from key presses, touchscreen manipulation, other device manipulation such as closing a slide cover or from voice command input. In the latter case, a speech recognition actor will be used to translate vocal commands into message commands sent to the engine. It is well known that speech recognition accuracy is enhanced by restricting the recognition vocabulary to the smallest possible context. In this invention, each scene that has a potential voice input has an associated context. The context may be conveniently stored as part of the presentation transform entity, and transmitted to the speech recognition actor along with the renderer content for the display or other multimedia output.

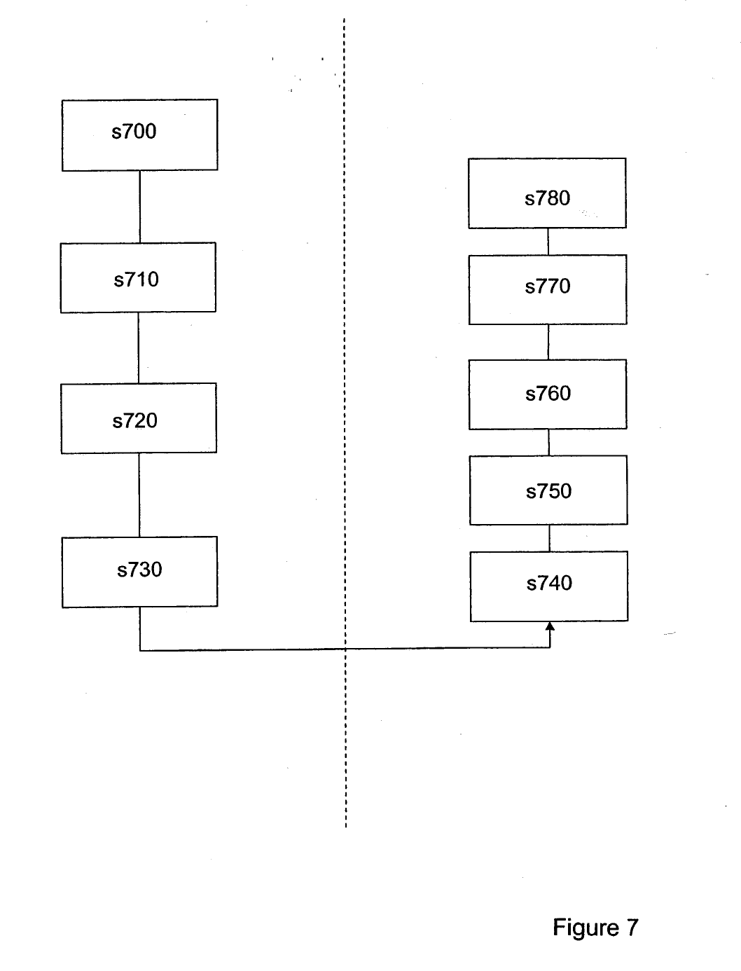

The present invention greatly reduces the effort and complexity required to develop a new MMI (and also to modify an existing MMI) when compared with known technologies. FIG. 7 shows a flowchart describing the process by which a MMI can be authored or modified. In step 700 the new MMI is defined and created using an authoring tool running on a personal computer or similar workstation. The output of the authoring tool is a description of the user interface in a mark-up language that is defined by a set of XML schema. As most current mobile communications terminals have significant limitations to their storage capacity and processing power, in step 710 the mark-up language is compiled into a set of serialized binary-format objects. These objects can then be further processed during step 720 to provide a delivery package that can be placed on a server ready for distribution to the mobile terminal.

At step 730 the MMI delivery package is transmitted to the mobile terminal, using for example, a data bearer of a wireless communications network where the package is received by the radio subsystem in the mobile terminal (step 740). The MMI delivery package is then unwrapped by the agent at step 750 to recreate the binary files. These files are then validated and installed within the resource manager of the terminal for subsequent use (step 760). Thus when the engine requires one of the MMI elements, such as a translation stylesheet for example, the newly downloaded style sheet can be passed to the engine (step 770) for processing before being sent to the renderer to be displayed to the user. (step 780). This technique also enables subsequent updates to be supplied to a mobile terminal in a very simple fashion. The updated entities can be compiled, packaged and transmitted, and the agent will ensure that only the newly received entity will be downloaded onto the terminal and that the entity to be replaced is deleted. It will be understood that any convenient means of delivery of MMI packages may be used with this invention, including wireless and wired communications and plug-in storage media.

As described above, the data objects that are transmitted to terminals in order to add or update a MMI are compiled from a mark-up language into binary code. The mark-up language uses a number of behaviour and presentation schemas to describe a MMI for mobile devices. The behaviour schemas referred to as the script comprise:

1. Reusable sets of strands which are threads of behaviour initiated by specific events in the phone;2. A description of how each page is built up from a set of page fragments (scenes);

3. A description of how each page fragment is built up from a set of queries that can be addressed to the components represented by actors, in order to populate a page with dynamic content (shot);

4. A set of page transition conditions, that is the renderer/logic events that cause the MMI to move from one page to another (scene change condition);

5. Page interrupt conditions, that is the renderer/logic events that cause a page context to be saved, interrupted and subsequently restored after a page sequence has completed (strand conditions); and

6. State transition machines for managing interaction between MMI events and logic events, for example describing how to handle an MP3 player when an incoming call occurs, and for allowing page content to be state-dependent (for example the background image of the page currently on display changing as a result of a new SMS message being received).

The presentation schemas comprise:

1. Transforms that describe how a presentation-free page fragment built by the MMI execution engine (within the portable device) can be converted into a presentation-rich format suitable for a specialised renderer (sets).

2. Transforms that describe how a language-neutral page fragment can be converted into a language-specific page fragment.

3. Transforms that describe how a presentation-free page assembled by the engine can be converted into a presentation-rich format for sending to a specialised renderer.

Additionally to the schemas described above, the mark-up language has the capability to handle and execute multimedia resources and files, including graphics, animations, audio, video, etc.

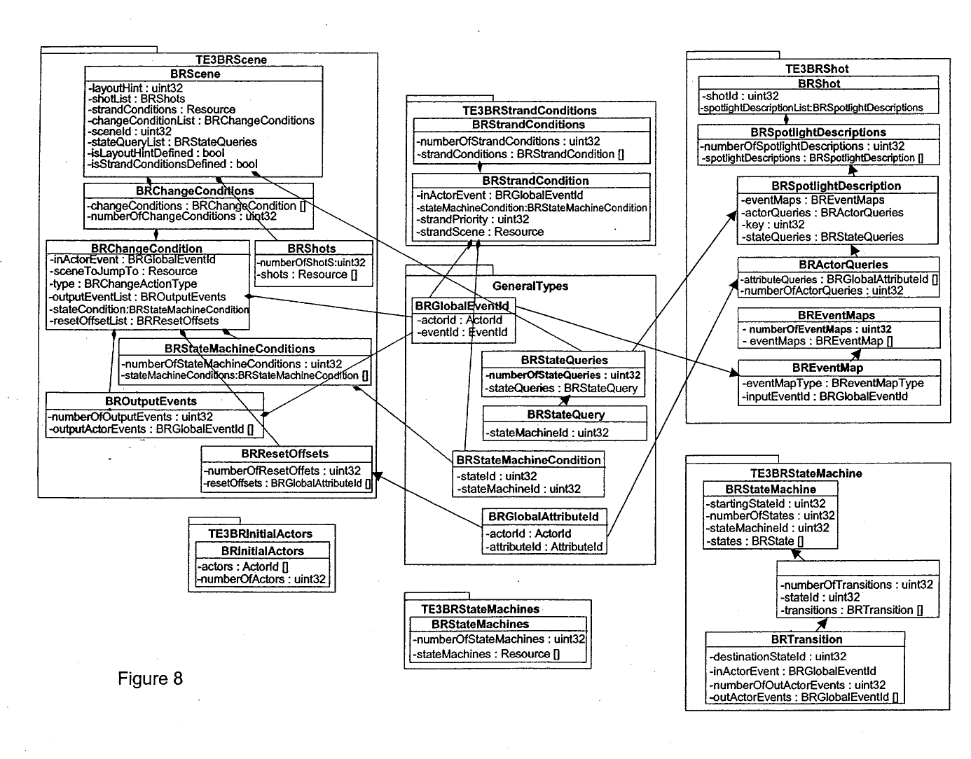

The compilation of the mark-up language into a set of serialized binary-format objects provides a further advantage in that the mark-up language does not need to be parsed by the wireless terminal. This has very significant implications for the design of the terminal as the terminal will be able to execute commands in response to user inputs more quickly (as each display update would require several ML objects to be parsed into binary). There will also be a saving made in the storage and memory requirements for the terminal, as the mark-up language text is less compact than the binary objects and there is no longer a need to supply an XML parser to convert the mark-up language into binary code. An implementation of the binary format is shown in FIG. 8. An example hexadecimal listing resulting from the binary compilation is shown below in Computer Program Listing B.

A still further advantage of the present invention is that the logic units that are represented by the actors are separate from the MMI. Thus the designer of the logic units does not need to know anything about the manner in which the data provided by the logic units will be used within the MMI (and similarly the MMI designer does not need to know anything about the logic units other than what data can be queried from them). This separation provides a number of advantages, for example: enabling the MMI to be changed rapidly if required (with the new code being uploaded to the communication device via a network entity if necessary); rewriting the MMI becomes a much simpler task and it is possible to provide several different presentation stylesheets within a wireless terminal, thereby allowing users to have a choice of several different MMIs, each with display characteristics of their own choosing.

Modifications and substitutions by one of ordinary skill in the art are considered to be within the scope of the present invention which is not to be limited except by the claims which follow.

COMPUTER PROGRAM LISTING A

```
<?xml version=“1.0” encoding=“UTF-8”?>
<!DOCTYPE SCRIPTCHUNK SYSTEM
“..\..\trigenix3engine\documentation\design and
architecture\schema\script.dtd”>
<!-- Yann Muller, 3G Lab -->
<!-- T68 Calculator menu -->
<SCRIPTCHUNK>
<ROUTINE ROUTINEID=“Calculator.Home”
STARTINGSCENEID=“Calculator.Home”
TEMPLATECHANGECONDITIONSID=“NestedRoutine”>
<!-- Calculator Home -->
<SCENE SCENEID=“Calculator.Home” LAYOUTHINT=“standard”
STRANBLOCKID=“standard”>
    <SHOTIDS>
        <SHOTID>Calculator.Memory</SHOTID>
        <SHOTID>Calculator.Operand1</SHOTID>
        <SHOTID>Calculator.Operand2</SHOTID>
        <SHOTID>Calculator.Result</SHOTID>
    </SHOTIDS>
    <CHANGECONDITIONS>
        <CHANGECONDITION SCENEID=“Organizer.Home”>
            <INACTOREVENT ACTORID=“keypad”
            EVENTID=“no”/>
        </CHANGECONDITION>
    </CHANGECONDITIONS>
</SCENE>
</ROUTINE>
<!-- Shots -->
<!-- Display of the calculator's memory -->
<SHOT SHOTID=“Calculator.Memory”>
    <SPOTLIGHTDESCRIPTION KEY=“Memory”>
        <EVENTMAPS>
            <ACTORQUERY ACTORID=“Calculator”
            ATTRIBUTEID=“Memory”/>
        </EVENTMAPS>
    </SPOTLIGHTDESCRIPTION>
</SHOT>
<!-- Display of the first operand -->
<SHOT SHOTID=“Calculator.Operand1”>
    <SPOTLIGHTDESCRIPTION KEY=“Operand1”>
        <EVENTMAPS>
            <ACTORQUERY ACTORID=“Calculator”
            ATTRIBUTEID=“Operand1”/>
        </EVENTMAPS>
    </SPOTLIGHTDESCRIPTION>
</SHOT>
<!-- Display of the operator and second operand -->
<SHOT SHOTID=“Calculator.Operand2”>
    <SPOTLIGHTDESCRIPTION KEY=“Memory”>
        <EVENTMAPS>
            <ACTORQUERY ACTORID=“Calculator”
            ATTRIBUTEID=“Operand2”/>
        </EVENTMAPS>
    </SPOTLIGHTDESCRIPTION>
</SHOT>
<!-- Display of the result -->
<SHOT SHOTID=“Calculator.Result”>
    <SPOTLIGHTDESCRIPTION KEY=“Result”>
        <EVENTMAPS>
            <ACTORQUERY ACTORID=“Calculator”
            ATTRIBUTEID=“Result”/>
        </EVENTMAPS>
    </SPOTLIGHTDESCRIPTION>
</SHOT>
<!-- Capabilities -->
<CAPABILITIES>
    <!-- attributes -->
    <CAPABILITY ID=“Memory” TYPE=“attribute”>
        <!-- the value of the memory -->
        <PARAMETER TYPE=“decimal” NAME=“Memory”/>
    </CAPABILITY>
    <CAPABILITY ID=“Operand1” TYPE=“attribute”>
        <!-- The first number of the current operation -->
        <PARAMETER TYPE=“decimal” NAME=“Number1”/>
    </CAPABILITY>
    <CAPABILITY ID=“Operand2” TYPE=“attribute”>
        <!-- The second number and the operator -->
        <PARAMETER TYPE=“string” NAME=“Operator”/>
        <PARAMETER TYPE=“decimal” NAME=“Number2”/>
    </CAPABILITY>
    <CAPABILITY ID=“Result” TYPE=“attribute”>
        <!-- The result -->
        <PARAMETER TYPE=“decimal” NAME=“Result”/>
    </CAPABILITY>
    <!-- eventsin -->
    <!-- eventsout -->
  </CAPABILITIES>
</SCRIPTCHUNK>
```

COMPUTER PROGRAM LISTING B

0000000 0000 0600 0000 0100 0000 0200 0000 0300
0000010 0000 0400 0000 0500 0000 0600 0000 0200
0000020 0001 0000 0101 ffff ffff 0000 0000 0000
0000030 0400 0000 0100 0000 0200 0000 0300 0000
0000040 0400 0000 0000 0000 0100 0000 0100 0000
0000050 0100 0000 0100 0000 0600 ffff ffff 0000
0000060 0000 0000 0000 0000 0200 0000 0100 0000
0000070 0200 0000 0100 0000 0600 ffff ffff 0000
0000080 0000 0000 0000 0000 0300 0000 0100 0000
0000090 0100 0000 0100 0000 0600 ffff ffff 0000
00000a0 0000 0000 0000 0000 0400 0000 0100 0000
00000b0 0300 0000 0100 0000 0600 ffff ffff 0000
00000c0 0000 0000 0000
00000c6

1. A mobile communications terminal comprising a presentation entity and a plurality of logical entities; the presentation entity comprising one or more presentation data sets and each logical entity having an associated software entity, a user interface for the mobile communications terminal being generated, in use, by polling one or more of the software entities to receive data representing a state of each associated logical entity and then arranging the received logical entity data in accordance with a presentation data set.

2. A mobile communications terminal according to claim 1, wherein the user interface for the terminal can be changed by applying a further presentation data set to the received logical entity data.

3. A mobile communications terminal according to claim 1, in which the user interface for the terminal can be updated by refreshing the data polled from the one or more software entities.

4. A mobile communications terminal according to claim 2 wherein the series of software entities that are polled is altered and the further presentation data set is applied to the altered logical entity data.

5. A mobile communications terminal according to claim 1, in which the terminal further comprises a display device on which the terminal user interface can be displayed.

6. A mobile communications terminal according claim 1, in which the terminal further comprises user input means.

7. A mobile communications terminal according to claim 1, in which the terminal further comprises a control entity that, in use, determines the software entities to be polled, receives the logical entity data from the polled software entities and applies a presentation data set to the received data to create a user interface data set.

8. A mobile communications terminal according to claim 7, in which the terminal further comprises a rendering entity, and, in use, the control entity sends the display data set to the rendering entity, the rendering entity transforming the user interface data set such that it can be displayed.

9. A mobile communications terminal according to claim 1, in which the presentation data set additionally comprises translation data.
